(19) United States
(12) Patent Application Publication
(10) Pub. No.: US 2025/0138146 A1
(43) Pub. Date: May 1, 2025

(54) ANALYZING CHIRPED WAVEFORMS IN REAL TIME USING PHOTONIC FRACTIONAL FOURIER TRANSFORMS

(71) Applicant: The Aerospace Corporation, El Segundo, CA (US)

(72) Inventors: Paul STEINVURZEL, Los Angeles, CA (US); George C. VALLEY, Los Angeles, CA (US); Uttam PAUDEL, La Palma, CA (US)

(73) Assignee: The Aerospace Corporation, El Segundo, CA (US)

(21) Appl. No.: 18/498,201

(22) Filed: Oct. 31, 2023

(51) Int. Cl. G01S 7/35

(52) U.S. Cl. CPC G01S 7/356

(57) ABSTRACT

Analyzing chirped waveforms in real time using photonic fractional Fourier transforms (FrFTs) is disclosed. Photonic signal processing, where mathematical operations are carried out by imprinting a signal onto a laser beam either temporally or spatially and propagating the signal through a series of optical elements that mimic the desired operation, can overcome the N² log N computational limitations of FrFTs with current techniques. This enables real time analysis using currently available computing and electronics technologies.

### FIELD

The present invention generally relates to signal processing, and more specifically, to analyzing chirped waveforms in real time using photonic fractional Fourier transforms (FrFTs).

### BACKGROUND

Various mission scenarios require real time interception and processing of unknown radio frequency (RF) signals. Frequency domain techniques such as filtered Fourier transforms (FTs) are effective and well known for processing signals with fixed carrier frequency. Modern frequency modulated continuous wave (FMCW) radar systems use a piecewise continuously varying carrier frequency (i.e., a chirped carrier frequency) as a means to boost the signal-to-noise ratio (SNR). In FMCW radar, the chirp rate can be changed on the fly. Such signals can be processed in real time with a matched filter if the chirp rate is known. However, if the chirp rate is unknown, this is not amenable to traditional FT analysis since the signal is distributed over many frequency components. Fractional Fourier transforms (FrFTs), where the basis functions are defined on a mixed time-frequency axis, can isolate chirped signals along the lines of an FT if the correct fractional order is applied.

The FrFT has been applied in numerous fields of research, including optics, quantum mechanics, image processing, and communications. The FrFT is a powerful tool that can extract signals from noise or separate two signals that overlap in time and/or frequency. The application of the FrFT lends itself particularly to the problem of separating multiple overlapping radar chirped signals. Chirps become tones in the proper FrFT domain, and hence can be readily extracted or notched (i.e., removed).

However, applying the FrFT to find chirped signals is computationally expensive, with a computational complexity that scales with N² log N, where N is the number of samples in the digitized signal. For high bandwidth signals, identifying the chirp rate using the FrFT becomes intractable with electronic processing using conventional hardware, particularly if real time analysis is required and/or if the signal is a piecewise linear continuous-wave (CW) modulation with multiple different chirps that are sequential in time. Existing techniques are limited in sensitivity, require long processing times, and have limited applicability to piecewise continuous chirped waveforms. Accordingly, an improved and/or alternative approach may be beneficial.

### SUMMARY

Certain embodiments of the present invention may provide solutions to the problems and needs in the art that have not yet been fully identified, appreciated, or solved by current signal processing technologies. For example, some embodiments of the present invention pertain to analyzing chirped waveforms in real time using photonic FrFTs.

In an embodiment, a chirped waveform analysis system configured to imprint a chirped waveform onto laser light and perform FrFT analysis includes a laser source with a spectrum consisting of n discrete narrowband lines, one or more electro-optic modulators to imprint the waveform onto the laser light, a frequency shifting loop (FSL) through which the modulated light propagates, a demultiplexer which separates each of the n laser lines into n unique paths, and n photodetectors and digitizers which individually detect and read out the intensity waveform at each wavelength. The FSL includes input and output couplers, which launch or extract laser light into or from the FSL, one or more optical isolators, to ensure one-way propagation through the FSL, a frequency shifter, which imparts a fixed shift to the carrier frequency of each laser line on every round trip through the loop, an optical amplifier, which amplifies all the laser lines to compensate losses through the loop, and an optical filtering module, which has n narrow passbands centered around each laser line and a flattening response to compensate for wavelength-dependent loss and gain from the other elements of the FSL. Once the carrier frequency of a laser line is shifted to an edge of a passband of the optical filtering module, the laser light is lost and no longer recirculates around the FSL. Likewise, the optical filtering module suppresses amplified spontaneous emission (ASE) generated by the optical amplifier that spectrally lies outside the passbands. Finally, the FSL is configured to be dispersive, with some known relationship between wavelength and roundtrip time per pass through the loop. This may be implemented by an additional dispersive element or by configuration of other elements of the FSL.

The measured intensity waveform at each wavelength is the FrFT of some unique order of the input RF signal. The FrFT order applied, and hence the chirp rate it matches, is determined by the relationship between the frequency shift applied by the frequency shifter and the wavelength-dependent round trip time through the FSL. If the intensity waveform measured at a particular wavelength consists of a periodic train of individual sharp peaks separated by the loop transit time, then the chirp rate matched to the fractional order applied for that wavelength is present in the RF signal.

In some embodiments, the laser source consists of n independent narrowband lasers which are multiplexed onto a common patch with a multiplexer, and the combined multiwavelength laser beam is modulated with the RF signal in a common modulator. In some embodiments, the n lasers are modulated individually with n modulators and then combined with a multiplexer onto a common path. In certain embodiments, the laser source is a mode-locked frequency comb, the spectrum of which includes n evenly spaced, discrete narrowband lines which are modulated with the RF signal in a modulator.

In some embodiments, the frequency shifter is an acousto-optic frequency shifter (AOFS), which is configured to shift carrier frequencies of the optical beam by a fixed amount via the Doppler effect. A magnitude of the frequency shift is selected based on parameters of the chirped waveform analysis system and a range of chirps to be measured for the one or more unknown signals in the input RF signal.

In some embodiments, the optical amplifier is an erbium-doped fiber amplifier (EDFA). In certain embodiments, the optical amplifier is a semiconductor optical amplifier. In some embodiments, the filtering module includes a Fabry-Perot type comb filter used in transmission, with an additional broadband filter to equalize the loss/gain through the loop across all n wavelengths. In certain embodiments, the filtering module includes an optical circulator and a sampled fiber Bragg grating (FBG) used in reflection, followed by an additional broadband filter to equalize the loss/gain through the loop across all n wavelengths. In some embodiments, the filtering module includes an optical circulator and n concatenated narrow band FBGs used in reflection, followed by an additional broadband filter to equalize the loss/gain through the loop across all n wavelengths. In certain embodiments, the filtering module includes an optical circulator and n concatenated narrow band FBGs used in reflection, where the FBG reflectivities are chosen to equalize the loss/gain through the loop across all n wavelengths. In some embodiments, the wavelength dependence of the loop round trip time is provided by appropriately spacing the n FBGs from each other in some order. In certain embodiments, the wavelength dependence of the loop round trip time is provided by high magnitude waveguide dispersion in a section of the loop. In some embodiments, the wavelength dependence of the loop round trip time is provided by an additional circulator and a broadband chirped FBG used in reflection.

In an embodiment, a chirped waveform analysis system configured to imprint a chirped waveform onto laser light and perform FrFT analysis includes a multiplexer configured to multiplex n different wavelengths into the laser light as a single optical beam that is modulated in amplitude by an input RF signal including one or more unknown signals. The chirped waveform analysis system also includes an FSL configured to propagate the optical beam. The FSL includes a frequency shifter configured to shift carrier frequencies of the optical beam by a fixed amount. A magnitude of the frequency shift is selected based on parameters of the chirped waveform analysis system and a range of chirps to be measured for the one or more unknown signals in the input RF signal. The FSL also includes n narrowband optical filters for each of the n wavelengths, the n narrowband optical filters configured to limit a number of round trips that the optical beam takes around the FSL. The chirped waveform analysis system further includes an optical amplifier configured to receive and amplify the optical beam from the optical amplifier to compensate for optical losses in the FSL and an optical isolator configured to receive the amplified optical signal from the optical amplifier. Once a carrier frequency of the optical beam is shifted to an edge of a passband of the n narrowband optical filters, the laser light of the optical beam is lost and no longer recirculates around the FSL. The FSL is configured to be dispersive with a known relationship between the carrier wavelength and a round trip time of the FSL.

In another embodiment, a chirped waveform analysis system includes an FSL configured to receive an optical beam including n different wavelengths of laser light modulated in amplitude by an RF signal including one or more unknown signals. The FSL is also configured to propagate the optical beam. The FSL includes a frequency shifter configured to shift carrier frequencies of the optical beam by a fixed amount. A magnitude of the frequency shift is selected based on parameters of the chirped waveform analysis system and a range of chirps to be measured for the one or more unknown signals in the input RF signal. The FSL also includes n narrowband optical filters for each of the n wavelengths. The n narrowband optical filters are configured to limit a number of round trips that the optical beam takes around the FSL. The chirped waveform analysis system also includes an optical amplifier configured to receive and amplify the optical beam from the optical amplifier to compensate for optical losses in the FSL and an optical isolator configured to receive the amplified optical signal from the optical amplifier. The FSL is configured to be dispersive with a known relationship between the carrier wavelength and a round trip time of the FSL.

In yet another embodiment, a chirped waveform analysis system includes an FSL configured to receive an optical beam including n different wavelengths of laser light modulated in amplitude by an RF signal including one or more unknown signals. The FSL is also configured to propagate the optical beam. The FSL includes a frequency shifter configured to shift carrier frequencies of the optical beam by a fixed amount. A magnitude of the frequency shift is selected based on parameters of the chirped waveform analysis system and a range of chirps to be measured for the one or more unknown signals in the input RF signal. The FSL also includes n narrowband optical filters for each of the n wavelengths. The n narrowband optical filters are configured to limit a number of round trips that the optical beam takes around the FSL. The chirped waveform analysis system also includes an optical amplifier configured to receive and amplify the optical beam from the optical amplifier to compensate for optical losses in the FSL and an optical isolator configured to receive the amplified optical signal from the optical amplifier. The chirped waveform analysis system further includes a first fiber optic coupler configured to receive output light from the optical isolator and provide portions of the received light to a demultiplexer and the FSL. The FSL is configured to be dispersive with a known relationship between the carrier wavelength and a round trip time of the FSL. The optical isolator is configured to let light propagate in a direction towards the fiber optic coupler.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating a frequency-shifting loop (FSL) system.

FIG. 2 is an architectural diagram illustrating a real time chirped waveform analysis system, according to an embodiment of the present invention.

FIG. 3 is an architectural diagram illustrating an experimental setup used to demonstrate the real time FrFT chirped waveform analysis concept, according to an embodiment of the present invention.

FIG. 4A is a graph illustrating a first set of measured oscilloscope time traces of two output photodetectors when the FSL is operated with two wavelengths near 1550 nm spaced by 115 GHz, according to an embodiment of the present invention shown in FIG. 3, where the RF signal to be measured has a chirp rate of −2 MHz/μs, the applied frequency shift is 8.6758 MHz, the FSL roundtrip time for the first wavelength is 118.5 ns, and the FSL roundtrip time for the second wavelength in 125.6 ns.

FIG. 4B is a graph 410 illustrating a second set of measured oscilloscope time traces of two output photodetectors when the FSL is operated with two wavelengths near 1550 nm spaced by 115 GHz, according to an embodiment of the present invention shown in FIG. 3, where the RF signal to be measured has a chirp rate of −2 MHz/μs, the applied frequency shift is 8.2222 MHz, the FSL roundtrip time for the first wavelength is 118.5 ns, and the FSL roundtrip time for the second wavelength in 125.6 ns.

FIG. 5 is an architectural diagram illustrating another real time chirped waveform analysis system, according to an embodiment of the present invention.

FIG. 6 is a perspective view illustrating a photonic integrated circuit that functions as an FrFT processor, according to an embodiment of the present invention.

FIG. 7 is a flowchart illustrating a process for analyzing chirped waveforms in real time using photonic FrFTs, according to an embodiment of the present invention.

FIG. 8 is an architectural diagram illustrating a computing system configured to analyze chirped waveforms in real time using photonic FrFTs, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to analyzing chirped waveforms in real time using photonic FrFTs. Photonic signal processing, where mathematical operations are carried out by imprinting a signal onto a laser beam either temporally or spatially and propagating the signal through a series of optical elements that mimic the desired operation, can overcome the computational limitations of FrFTs noted above. This enables real time analysis using currently available computing and electronics technologies. Such embodiments may be useful for telecommunications, signal intelligence, etc.

The all-optical implementations of FrFTs of some embodiments provide processing speeds that would otherwise be limited by read-out electronics. Parallelization of FrFT via wavelength encoding has no electronic analog. The marginal cost in size, weight, and power (SWaP) for parallelizing with more wavelengths is considerably less than parallelization using multiple field programmable gate arrays (FPGAs) and/or graphical processing units (GPUs). Furthermore, some embodiments can be implemented using proven commercial off-the-shelf (COTS) components, potentially improving stability and reliability.

A FrFT photonic processor based on a frequency shifting loop was demonstrated in Schnébelin et al., “Agile Photonic Fractional Fourier Transformation of Optical and RF Signals,” Optica, Vol. 4, No. 8, pp. 907-910 (August 2017). A RF signal is imprinted on laser light using an electro-optic modulator. The light is injected into an optical fiber loop, where the loop round trip time τ_{c} is much smaller than the signal temporal width, and for every round trip, the optical carrier frequency is shifted by some fixed value fₛ. The output of the loop therefore consists of the interference of many copies of the original light signal, each shifted in frequency and time by fₛ and τ_{c} respectively.

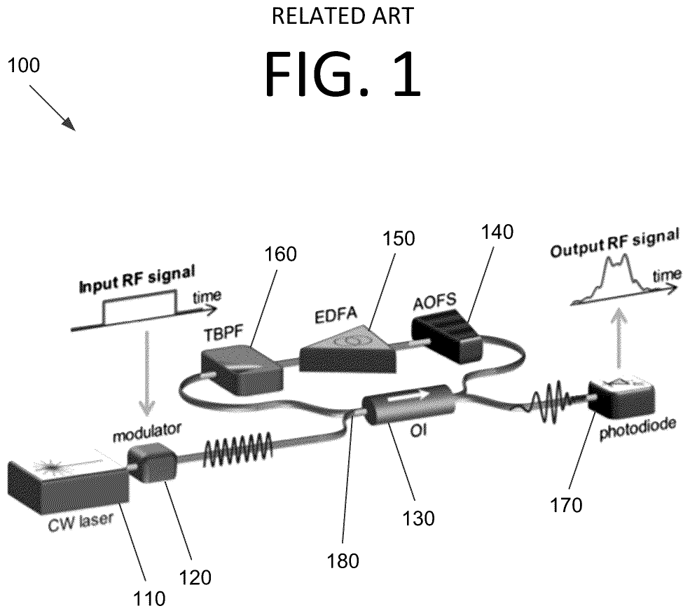

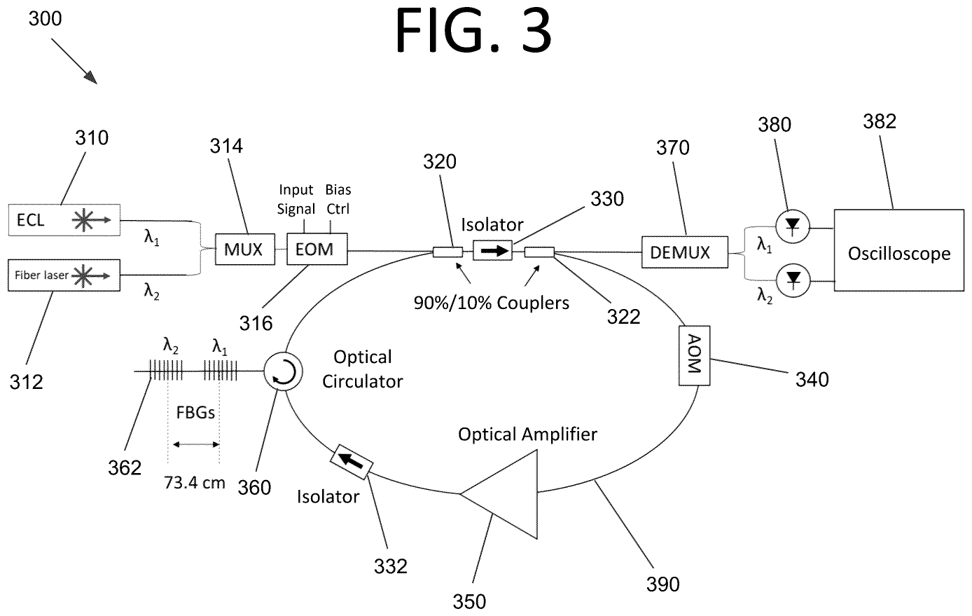

As shown in FIG. 1, which corresponds to FIG. 3(a) of Schnébelin et al., the frequency-shifting loop (FSL) system 100 includes a narrow line width (i.e., less than 10 kHz full width at half maximum (FWHM)) continuous wave (CW) laser 110, a modulator 120 to amplitude modulate and/or phase modulate the laser light, an optical isolator 130 to ensure unidirectional propagation, an AOFS 140, an EDFA 150 to compensate for loss, a tunable bandpass filter (TBPF) 160 to limit the number of round trips through the FSL and to suppress amplified spontaneous emission (ASE), and a photodiode 170. Light is injected into and extracted from the FSL via fused fiber couplers 180. It can be shown mathematically that the measured interference at the loop output consists of a periodic train of pulses with period τ_{c}, where the pulse waveform takes the shape of a FrFT of the input signal.

When the FrFT order a is matched to a chirp rate C of the signal to be measured, the frequency shifting loop essentially adds a quadratic phase that exactly offsets the quadratic phase present in the chirped signal. It can be shown that this condition is satisfied when:

$$\frac{cot ( α )}{2 π} = - \frac{Δ f}{{τ}_{c}} = C \qquad ( 1 )$$

$$where$$

$${f}_{C} = \frac{m}{{τ}_{c}} \qquad ( 2 )$$

$$Δ f = {f}_{s} - {f}_{C} \qquad ( 3 )$$

and m is an integer.

In order to determine the linear chirp of an unknown signal, the fractional order should be matched to the chirp rate. This can be accomplished by sweeping the value of Δf serially in time to find the point at which the measured FrFT is maximally sharp and narrow. When the FrFT order is matched to the chirp rate, it can be shown that the waveform shape of the periodic pulses measured at the output photodiode is proportional to the square modulus of the FT of the RF signal envelope function. The envelope function of a FMCW radar signal is constant, so when the FrFT order is matched to the signal chirp rate, the output photodiode time trace should approximate a periodic series of Dirac delta functions. It is known that this procedure of sharpening the FrFT can find FMCW radar signals at very small SNRs. See Othman et al., “On Radar Detection of Chirp Signals with Nondeterministic Parameters in Challenging Noise Background,” 2013 IEEE Radar Conference, Ottawa, Canada (RadarCon13).

While this optical technique has been shown to work experimentally, it still does not solve the problems posed by real-time processing needs. For example, the unknown signal must be periodic to perform a series of FrFT measurements as a function of fₛ to find C. Accordingly, some embodiments enable real time FrFT photonic processing by cloning the signal at multiple wavelengths λ and adding a wavelength-dependent dispersive element to the frequency shifting loop. As a result, τ_{c} is no longer a constant, but rather becomes τ_{c} (λ). Thus, by carrying out a set of parallel measurements at a fixed fₛ, but varying λ, different values of τ_{c} and Δf are applied in parallel.

In such embodiments, the unknown RF signal to be measured modulates multiple laser wavelengths that are then multiplexed into a single fiber by wavelength division multiplexing (WDM) technology. In some embodiments, the laser wavelengths may first be multiplexed and then modulated by a single common modulator. For example, 50 to 100 lasers covering the C-band centered at 1550 nm may be used. In some embodiments, a single laser emits many wavelengths and no multiplexing is required. The fiber output from the modulator is connected to a fused coupler to allow injection of the signal into the frequency shifting loop.

The loop design includes an acousto-optic frequency shifter, an optical amplifier, and an optical isolator. However, instead of a single bandpass filter, multi-wavelength embodiments use a series of narrow-band FBGs, F-P comb filters, or another suitable filtering component operated either in transmission or in reflection with a circulator. F-P comb filters can provide narrow passbands uniformly spaced in frequency. However, FBGs can be used to put arbitrary lengths of fiber therebetween and arrange the FBGs in any order. Thus, the functional form of τ_{c}(λ) may follow any shape, even a pseudo-random profile, with the restriction that each delay value must be unique. With F-P comb filters, group delay dispersion would be added (e.g., with length of highly dispersive fiber). Both filtering and dispersion may be added with a bulk grating pair, but this would entail a free-space device.

Each FBG is centered at one of the wavelengths in the bank of lasers, and the FBGs are each separated by some distance L. The round trip time τ_{c} then becomes a function of wavelength τ_{c}(λ) since the distance between each FBG and the circulator imparts a unique delay time. At the output of the loop, a second WDM separates the wavelengths into separate channels and the FrFT of each wavelength is read out in parallel with a bank of photodetectors. Unlike dispersive elements based on refractive index or waveguiding properties, a unique advantage of using discrete FBGs is that τ_{c}(λ) can be any arbitrary function and need not be monotonic, which may help minimize system impairments due to cross channel leakage at the output.

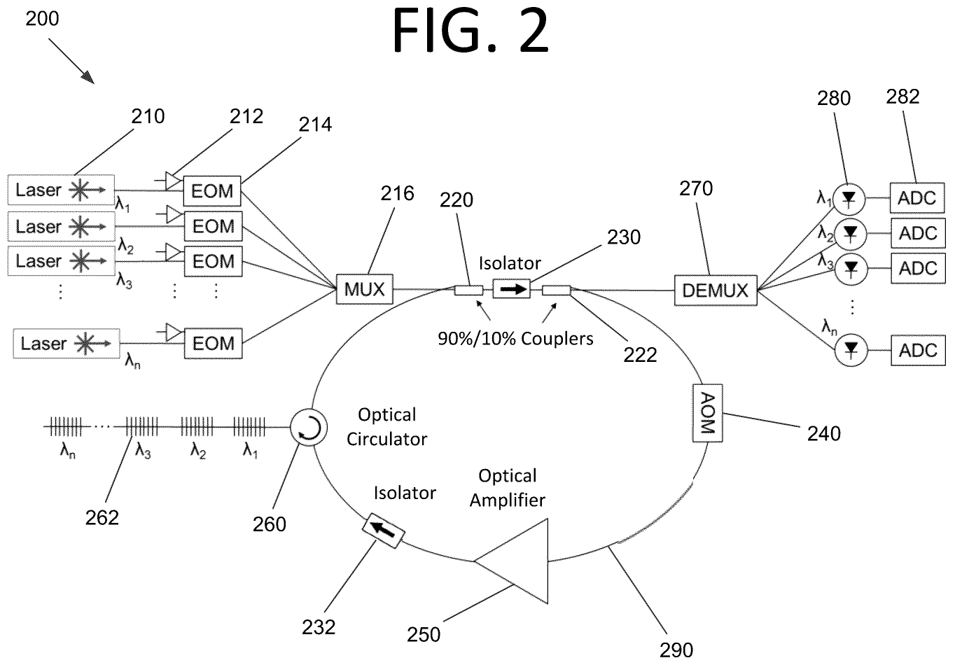

FIG. 2 is an architectural diagram illustrating a real time chirped waveform analysis system 200, according to an embodiment of the present invention. System 200 functions as a real time FrFT photonic processor by parallelizing the FrFT in hardware. The input RF signal drives modulators that encode the signal onto n wavelengths, which are in turn multiplexed into a dispersive FSL. In other words, the signal is “cloned” at n wavelengths. The output of the dispersive FSL is demultiplexed onto n respective photodetectors. The wavelength dependence of the transit time through the FSL leads to wavelength dependence of the fractional order. The chirp rate C is determined by identifying the wavelength that gives sharpest peaks at the output (implying that the fractional order is matched) and then calculating C using Eqs. (1)-(3) above.

A selected number n of lasers 210, each at a unique wavelength λ₁, λ₂, λ₃, . . . , λₙ feed light into n respective electro-optical modulators 214 (e.g., electro-optical amplitude modulators (EOAMs)), which are driven by the same RF signal to be analyzed 212. The modulated output signals from electro-optical modulators (EOMs) 214 are fed into a multiplexer 216, and the combined signal is guided to an input 90%/10% fiber optic coupler 220. However, different light percentages for each output may be used without deviating from the scope of the invention. The coupling ratio may be wavelength-dependent to equalize the seed power into loop. Coupler 220 injects light from multiplexer 216 into FSL 290.

The arm coming from multiplexer 216 delivers 10% of its light to a first isolator 230, which lets light propagate in the direction indicated by the arrow. The arm coming from an optical circulator 260 delivers 90% of its light to first isolator 230. The arm coming from multiplexer 216 sees only one pass, whereas the arm coming from optical circulator 260 sees many passes and gives a much larger contribution to system loss, as such, this arm has the higher transmission).

A second 90%/10% fiber optic coupler 222 delivers 10% of its light to a demultiplexer 270 and 90% of its light to FSL 290. However, in some embodiments, a single optical coupler is used. In such embodiments, first isolator 230 would be the first element after multiplexer 216 and the single fiber optic coupler would follow first isolator 230.

90% of the light from coupler 222 is delivered via FSL 290 to acousto-optic modulator AOM 240, also called an AOFS herein, which is a device that modifies the frequency of the optical beam via the Doppler effect. In this embodiment, the frequency of AOM 240 is preset based on the relevant parameters of system 200 (e.g., longer loops generally require smaller frequency shifts) and the range of chirps to be measured. The acoustic wave travelling through a crystal of AOM 240 creates a traveling refractive index grating, which reflects the incident optical beam to the device output. Since the grating is moving, the carrier frequency of the reflected beam sees an increase or decrease by an amount equal to the RF driving frequency of AOM 240 and this is how shifting of the frequency is controlled in FSL 290. AOM 240 takes a relatively high power RF sinusoid as an input, so the driver may be as simple as a voltage controlled oscillator (VCO) and an RF amplifier. Commercial AOMs are generally sold with a driver box that takes a direct current (DC) voltage as an input to control the frequency. The output from AOM 240 passes through an optical amplifier 250 and on through a second isolator 232.

Output from optical amplifier 250 is provided to optical circulator 260, which is a three port optical circulator in this embodiment. Optical circulator 260 directs the light to a series of narrowband, high reflectivity FBGs 262 for each of wavelengths λ₁, λ₂, λ₃, . . . , λₙ. The number of round trips is set by the filter bandwidth of FBGs 262 and where the input laser wavelength sits relative to the filter center. On each round trip, the optical carrier is shifted in frequency such that the optical carrier moves relative to the filter center until it hits one of the passband edges. At this point, the optical carrier begins to pass through the filter and not recirculate. Thus, once the frequency is shifted to the passband edge, the light passes through all FBGs 262 and is guided to a beam dump or just out to free space, where the fiber end is angle polished and/or anti-reflection (AR) coated to inhibit back reflections into the FSL. The same happens for the ASE emission from the optical amplifier, which lies between the passbands of FBGs 262. For this reason, it is important that FBGs 262 are well separated by spectral regions with little or no reflection. In other words, the FBG filter shape should have steep sidewalls.

FBGs 262 provide additional functionality in determining the relationship between round trip time and wavelength. This relationship depends on how FBGs 262 are spaced and in what order. In principle, FBGs 262 can provide a gain flattening functionality as well by controlling the reflectivity of FGBs 262.

If optical amplifier 250 is an EDFA, this type of amplifier typically has wavelength-dependent gain. Since there are many roundtrips through such an EDFA via FSL 290, moderate gain differences can turn into very large differences, and the output of FSL 290 could be dominated by a few wavelengths such that other wavelengths may not work at all. However, if the reflectivity of each FBG 262 is tailored such that the net gain/loss through the loops is roughly equal for all wavelengths, FSL 290 will function more effectively. In the case of EDFAs, it should be kept in mind that changing the EDFA pump power changes the required gain flattening profile. As such, a separate gain flattening filter may be provided after the EDFA for such embodiments.

FBGs 262 provide different length cavities for different wavelengths and different FrFT orders. The FrFT order is dependent on the relationship between the cavity length and frequency shift applied by the AOFS. This filtered light is then reflected back into optical circulator 260 and back to coupler 220.

FSL output from coupler 222 is guided to demultiplexer 270, per the above. This output is an interferogram of k copies of the input waveform shifted in time and frequency and is mathematically equivalent to a periodic waveform with period t, and waveform shape proportional to the FrFT of the RF signal. The fractional order depends on the relationship between the frequency shift and the transit time through the loop. FrFTs of many orders are calculated simultaneously-one per wavelength.

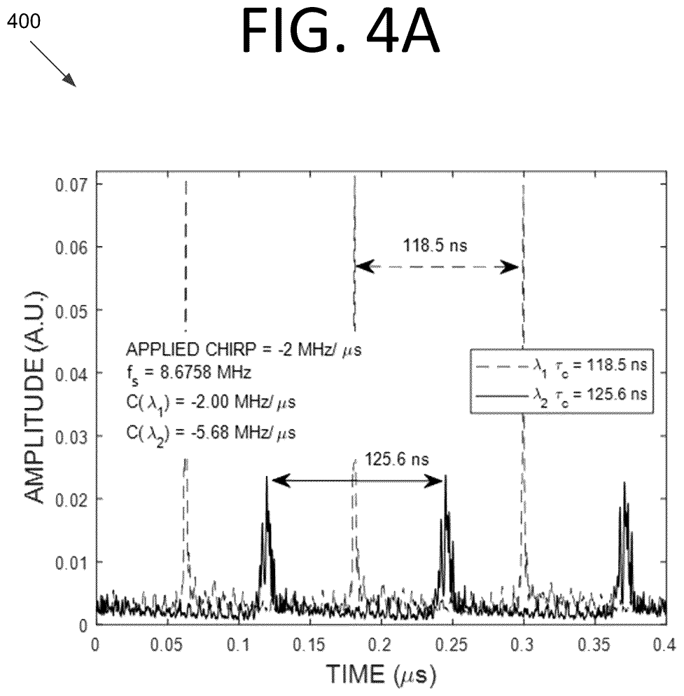

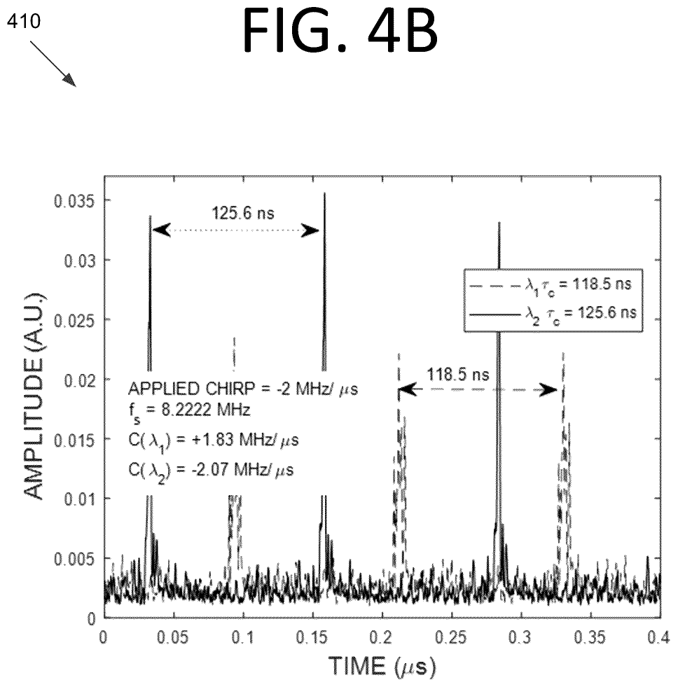

Demultiplexer 270 splits wavelengths λ₁, λ₂, λ₃, . . . , λₙ to respective photodetectors 280 (e.g., photoconductors, phototransistors, etc.). The analog output signal from each photodetector 280 is read out by a respective analog-to-digital converter (ADC) 282. The digital signals from ADCs 282 are then provided to a computing system for analysis, such as computing system 400 of FIG. 4, or to an oscilloscope (not shown).

The wavelength-dependent version of Eq. (1) can be recast to give the chirp rate C:

$$C = \frac{m}{{τ}_{C}^{2} ( λ )} - \frac{{f}_{s}}{{τ}_{C} ( λ )} \qquad ( 4 )$$

The λ with the maximally narrow/peaked output has the round trip time that gives the right FrFT in order to match the chirp rate C. Since the loop transit time is a function of wavelength and the applied frequency shift is known, it is known how the applied FrFT order changes with the wavelength, as well as what chirp rate the given FrFT order will match/demodulate. System 200 produces n periodic waveforms-one per wavelength. It is identified which wavelength gives delta functions, what round trip time gives the delta functions, and what FrFT order and chirp rate were obtained.

Some embodiments can also rapidly detect piecewise-linear FMCW radar signals since the FrFTs are obtained as function of time. The first linear segment with the first chirp rate would show up at the detector for wavelength λᵢ corresponding to its chirp rate. The second segment would show up later at the detector for wavelength λⱼ corresponding to its chirp, and so forth. Subscripts i and j are used synonymously with the subscripts of λ₁, λ₂, λ₃, . . . , λₙ in this context. Similarly, if multiple chirped RF signals are present, they can be detected simultaneously.

If the chirp parameter is changing rapidly as a function of time, this may be discovered using system 200, for example. The “high points” in the changing wavelengths over time may be observed. Although any desired number of channels may be processed without deviating from the scope of the invention, even just being able to accommodate ten channels simultaneously is a significant advance over what is currently possible.

In some embodiments, a photonic integrated circuit may be used. Instead of fibers, a photonic circuit of waveguides would be fabricated on a wafer (e.g., Si, LiNbO₃, SiO₂, etc.). Couplers can be made in this platform by placing two waveguides side-by-side. Comb filters can be made by sandwiching a resonator or a series of resonators between two waveguides. Integrated AOMs have been demonstrated in thin film LiNbO₃, and optical waveguide amplifiers have been demonstrated. Semiconductor optical amplifiers could be an option as well depending on power/gain needs and if the loop transit time is short enough. Differential delay/dispersion can be achieved by making the waveguide dispersive.

If a mesh filter is used for the chirp rates of interest, a certain chirp rate, pattern, etc. may be sought. System 200 calculates n FrFTs, each with a unique order. However, these are discrete quantities that are matched to a discrete set of chirp rates. Thus, some embodiments address what to do if the chirp rate of the signal to be measured is not one of these discrete values. If off-peak, these chirp rates/patterns can be matched to a particular rotation of the angle. For example, if you have 10 channels and 8 out of 10 show nothing, but two have a more pronounced peak, the chirp parameter can be found for an unknown signal. The frequency shift is tunable in some embodiments as well, which shifts the entire set of discrete chirp rates that can be measured.

FIG. 3 is an architectural diagram illustrating an experimental setup 300 used to demonstrate the real time FrFT chirped waveform analysis concept, according to an embodiment of the present invention. Similar to real time chirped waveform analysis system 200 of FIG. 2, experimental setup 300 includes multiplexer 314, FSL 390, couplers 320, 322, isolators 330, 332, AOM 340 (which is an AOFS), optical amplifier 350, optical circulator 360, and demultiplexer 370. In this embodiment, only two FrFT orders can be applied simultaneously, wherein laser light from an external cavity laser (ECL) 310 is provided to multiplexer 314 at wavelength λ₁ and laser light from a fiber laser 312 is provided to multiplexer 314 at wavelength λ₂. The multiplexed optical beam from multiplexer 314 is provided to an EOM 316, which also receives an input signal and bias control. Output from EOM 316 is then provided to coupler 320. Also, instead of an array of FBGs 262 of system 200 of FIG. 2, a pair of FBGs 362 are provided for each wavelength and separated by 73.4 centimeters (cm).

Similarly, a pair of photodetectors 380 are provided for each wavelength and operably connected to demultiplexer 370. An oscilloscope 382 allows a user to view the waveforms for λ₁ and λ₂. One intent of the experiment was to demonstrate the real time FrFT concept using two wavelengths separated by 100 gigahertz (GHz) to show that cross-channel leakage between adjacent channels is suppressed with standard COTS multiplexers. The actual spacing was 115 GHz due to the availability of FBGs. Experimental setup 300 was used to generate the data shown in graphs 400, 410 of FIGS. 4A and 4B.

FIG. 4A is a graph 400 illustrating a first set of measured oscilloscope time traces of two output photodetectors when the FSL is operated with two wavelengths near 1550 nanometers (nm) spaced by 115 GHz, according to an embodiment of the present invention. The wavelength λ₁ has a shorter path length through the loop than λ₂ by 7.1 nanoseconds (ns). The AOFS imparts a frequency shift of 8.6758 megahertz (MHz) to the optical carrier frequencies on each round trip. With these parameters, λ₁ demodulates RF signals chirped at −2.00 MHz/μs and λ₂ demodulates at −5.68 MHz/μs. When the input RF signal is chirped at −2.00 MHz/μs, the time trace of λ₁ shows a series of sharp peaks separated by the loop roundtrip time. FIG. 4B is a graph 410 illustrating a second set of measured oscilloscope time traces of two output photodetectors when the FSL is operated with two wavelengths near 1550 nm spaced by 115 GHz, according to an embodiment of the present invention. With these parameters, λ₁ demodulates RF signals chirped at +1.83 MHz/μs and λ₂ demodulates at −2.07 MHz/μs. When the input RF signal is chirped at −2.00 MHz/μs, the time trace of λ₂ shows a series of sharp peaks separated by the loop roundtrip time.

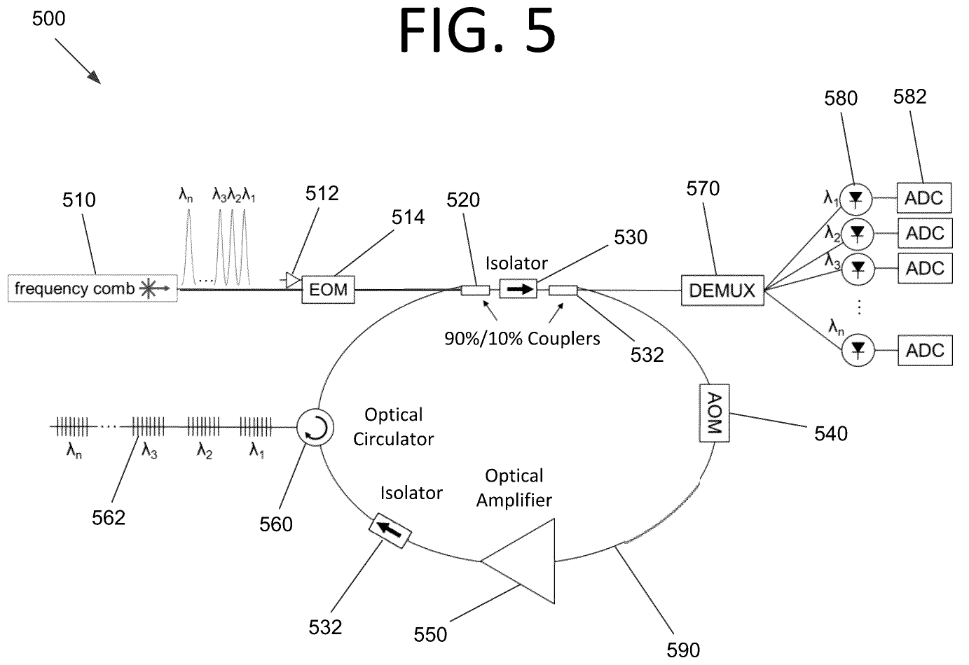

FIG. 5 is an architectural diagram illustrating another real time chirped waveform analysis system 500, according to an embodiment of the present invention. FSL 590, couplers 520, 522, isolators 530, 532, AOM 540, optical amplifier 550, optical circulator 560, FBGs 562, demultiplexer 570, photodetectors 580, and ADCs 582 are identical to those of real time chirped waveform analysis system 200 of FIG. 2. However, in system 500, the laser source is an optical frequency comb 510, which feeds into a single EOM 514 driven by an RF signal to be analyzed 512.

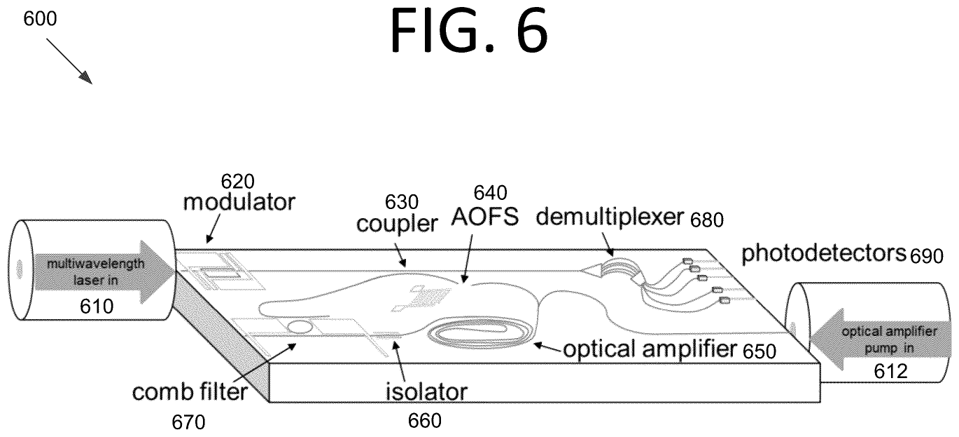

FIG. 6 is a perspective view illustrating a photonic integrated circuit 600 that functions as an FrFT processor, according to an embodiment of the present invention. Multi-wavelength laser light 510 is input to an optical modulator 520. and light from an optical amplifier pump 512 is provided to optical amplifier 550. Optical modulator is operably connected to optical coupler 530. AOFS 540 is operably connected to optical coupler 530 and optical amplifier 500 which, in turn, is operably connected to isolator 560. Isolator 560 is also operably connected to a comb filter 570. Integrated optical waveguides connect AOFS 540, optical amplifier 550, isolator 560, and comb filter 570, which form an FSL. Output from optical coupler 530 is provided to demultiplexer 580, and respective wavelengths are provided to photodetectors 590. AOFS 540 is depicted as a transducer that induces the acoustic wave and two terminated waveguides. With the transducer on, light exiting the first waveguide is reflected up into the second waveguide.

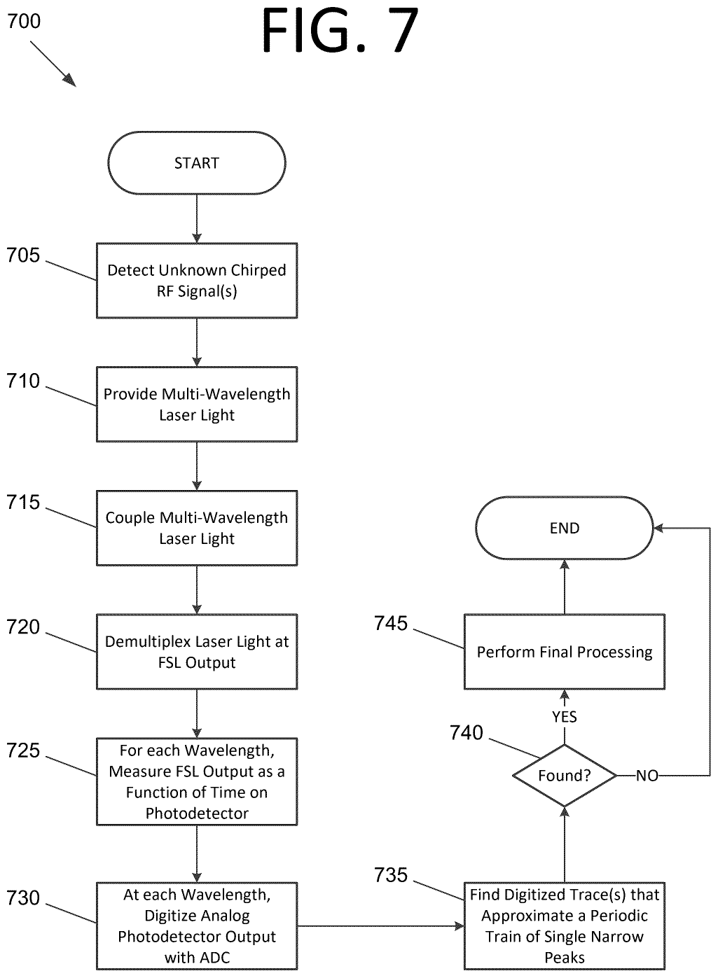

FIG. 7 is a flowchart illustrating a process 700 for analyzing chirped waveforms in real time using photonic FrFTs, according to an embodiment of the present invention. The process begins with detecting unknown chirped RF signal(s) at 705. Multi-wavelength laser light at n unique wavelengths is then modulated using the RF waveform of the detected unknown chirped RF signal(s) as an input RF signal at 710, encoding the input RF signal into the n wavelengths. The n wavelengths are multiplexed and coupled into an FSL at 715. However, in some embodiments, the laser light may be multiplexed before modulation is performed. The multiplexed laser light is demultiplexed at an output of the FSL at 720.

For each demultiplexed wavelength, the FSL output is measured as a function of time on a photodetector at 725. At each wavelength, the analog output of each photodetector is digitized by an ADC at 730. A computing system, oscilloscope, or other suitable electronic device then finds digitized trace(s) that approximate a periodic train of single narrow peaks at 735.

If the chirp rate is found at 740, final processing is performed at 745 and the process ends. More specifically, the device of some embodiments provides two outputs: (1) whether a chirped signal was detected; and (2) if so, what the sign and magnitude of the chirped waveform. What this information is used for depends on the application.

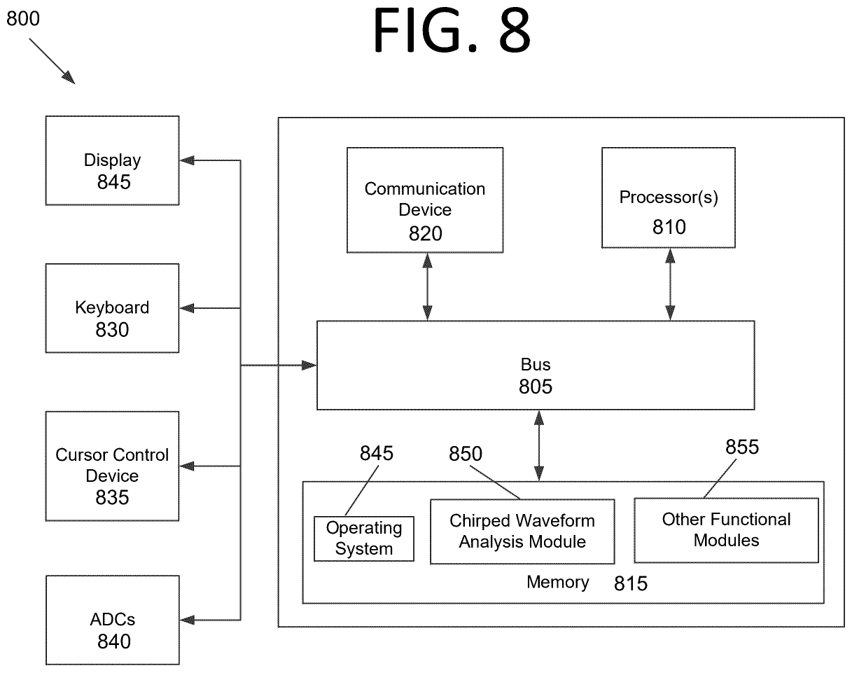

FIG. 8 is an architectural diagram illustrating a computing system 800 configured to analyze chirped waveforms in real time using photonic FrFTs, according to an embodiment of the present invention. Computing system 800 includes a bus 805 or other communication mechanism for communicating information, and processor(s) 810 coupled to bus 805 for processing information. Processor(s) 810 may be any type of general or specific purpose processor, including a Central Processing Unit (CPU), an Application Specific Integrated Circuit (ASIC), an FPGA, a GPU, multiple instances thereof, and/or any combination thereof. Processor(s) 810 may also have multiple processing cores, and at least some of the cores may be configured to perform specific functions. Multi-parallel processing may be used in some embodiments. In some embodiments, neuromorphic circuits may not require the typical components of a Von Neumann computing architecture.

Computing system 800 further includes memory 815 for storing information and instructions to be executed by processor(s) 810. Memory 815 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 810 and may include volatile media, non-volatile media, or both. The media may also be removable, non-removable, or both.

Additionally, computing system 800 includes a communication device 820, such as a transceiver, to provide access to a communications network via a wireless and/or wired connection. In some embodiments, communication device 820 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 820 may include one or more antennas that are singular, arrayed, phased, switched, beamforming, beamsteering, a combination thereof, and or any other antenna configuration without deviating from the scope of the invention.

Processor(s) 810 are further coupled via bus 805 to a display 825, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 825 may be configured as a touch (haptic) display, a three dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 830 and a cursor control device 835, such as a computer mouse, a touchpad, etc., are further coupled to bus 805 to enable a user to interface with computing system 800. However, in certain embodiments, a physical keyboard and mouse may not be present, and the user may interact with the device solely through display 825 and/or a touchpad (not shown). Any type and combination of input devices may be used as a matter of design choice. In certain embodiments, no physical input device and/or display is present. For instance, the user may interact with computing system 800 remotely via another computing system in communication therewith, or computing system 800 may operate autonomously. ADCs 840 provide digital signals for respective wavelengths converted from analog output from respective photodetectors.

Memory 815 stores software modules that provide functionality when executed by processor(s) 810. The modules include an operating system 845 for computing system 800. The modules further include a chirped waveform analysis module 850 that is configured to analyze chirped signals. Computing system 800 may include one or more additional functional modules 855 that include additional functionality.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A chirped waveform analysis system configured to imprint a chirped waveform onto laser light and perform fractional Fourier transform (FrFT) analysis, comprising:
a multiplexer configured to multiplex n different wavelengths into the laser light as a single optical beam that is modulated in amplitude by an input radio frequency (RF) signal comprising one or more unknown signals; and
a frequency-shifting loop (FSL) configured to propagate the optical beam, the FSL comprising:
a frequency shifter configured to shift carrier frequencies of the optical beam by a fixed amount, wherein a magnitude of the frequency shift is selected based on parameters of the chirped waveform analysis system and a range of chirps to be measured for the one or more unknown signals in the input RF signal, and
n narrowband optical filters for each of the n wavelengths, the n narrowband optical filters configured to limit a number of round trips that the optical beam takes around the FSL;
an optical amplifier configured to receive and amplify the optical beam from the optical amplifier to compensate for optical losses in the FSL; and
an optical isolator configured to receive the amplified optical signal from the optical amplifier, wherein
once a carrier frequency of the optical beam is shifted to an edge of a passband of the n narrowband optical filters, the laser light of the optical beam is lost and no longer recirculates around the FSL, and
the FSL is configured to be dispersive with a known relationship between the carrier wavelength and a round trip time of the FSL.

2. The chirped waveform analysis system of claim 1, wherein the FSL further comprises an optical circulator configured to receive the optical beam from the acousto-optic frequency shifter, send the shifted optical beam to the plurality of optical filters, receive the optical beam from the plurality of optical filters, and output the optical beam.

3. The chirped waveform analysis system of claim 1, further comprising:
n electro-optical modulators configured to receive and be driven by an input radio frequency (RF) signal, the n electro-optical modulators configured to encode the input RF signal into laser light at a respective wavelength of the n wavelengths; and
a multiplexer configured to receive the encoded laser light from the n electro-optical modulators, combine the encoded laser light into the optical beam, and provide the optical beam to the FSL at a location in an optical path of the optical beam prior to the acousto-optic frequency shifter.

4. The chirped waveform analysis system of claim 1, further comprising:
a demultiplexer at an output of the FSL, the demultiplexer configured to receive the optical beam from the FSL and demultiplex the optical beam into the n wavelengths; and
n photodetectors configured to receive a respective wavelength of the n wavelengths and measure an intensity waveform of the respective wavelength and produce an analog electrical output responsive thereto, wherein
output from the demultiplexer is a unique order of the input RF signal.

5. The chirped waveform analysis system of claim 4, further comprising:
n analog-to-digital converters (ADCs) configured to receive the analog electrical output from the respective photodetectors, convert the received analog electrical output into a digital signal, and output the digital signal.

6. The chirped waveform analysis system of claim 5, further comprising:
a computing system or an oscilloscope configured to receive the digital signals output by the n ADCs and determine the FrFT order that was applied and the chirp rate that the FrFT order matches by a relationship between the frequency shift applied by the AOFS and the wavelength-dependent round trip time through the FSL, wherein
when the intensity waveform measured at a particular wavelength comprises a periodic train of individual sharp peaks separated by the loop transit time of the FSL, the chirp rate associated with the FrFT order applied for that wavelength is present in the input RF signal.

7. The chirped waveform analysis system of claim 1, further comprising:
an optical isolator configured to receive the output light from the multiplexer and the optical circulator; and
a first fiber optic coupler configured to receive output light from the optical isolator and provide portions of the received light to the demultiplexer and the FSL, wherein
the optical isolator is configured to let light propagate in a direction towards the fiber optic coupler.

8. The chirped waveform analysis system of claim 7, wherein the first fiber optic coupler is configured to provide a larger portion of its received light to the FSL than to the demultiplexer.

9. The chirped waveform analysis system of claim 7, further comprising:
a second fiber optic coupler located between the multiplexer and the circulator and the optical isolator.

10. The chirped waveform analysis system of claim 9, further comprising:
a first fiber optic arm connecting the multiplexer to the second fiber optic coupler; and
a second fiber optic arm connecting the optical circulator to the second fiber optic coupler, wherein
light traveling along the first arm takes one pass around the FSL, and
light traveling around the second arm takes multiple passes around the FSL.

11. The chirped waveform analysis system of claim 1, further comprising:
n lasers for each of the n electro-optical modulators, each of the n lasers configured to emit the laser light at the n respective wavelengths for each of the respective electro-optical modulators

12. The chirped waveform analysis system of claim 1, wherein
the n wavelengths are separated from one another by a distance L.

13. The chirped waveform analysis system of claim 1, wherein the n narrowband optical filters are configured as a single element comb filter.

14. A chirped waveform analysis system, comprising:
a frequency-shifting loop (FSL) configured to receive an optical beam comprising n different wavelengths of laser light modulated in amplitude by an input radio frequency (RF) signal comprising one or more unknown signals, and configured to propagate the optical beam, the FSL comprising:
a frequency shifter configured to shift carrier frequencies of the optical beam by a fixed amount, wherein a magnitude of the frequency shift is selected based on parameters of the chirped waveform analysis system and a range of chirps to be measured for the one or more unknown signals in the input RF signal, and
n narrowband optical filters for each of the n wavelengths, the n narrowband optical filters configured to limit a number of round trips that the optical beam takes around the FSL;
an optical amplifier configured to receive and amplify the optical beam from the optical amplifier to compensate for optical losses in the FSL; and
an optical isolator configured to receive the amplified optical signal from the optical amplifier, wherein
the FSL is configured to be dispersive with a known relationship between the carrier wavelength and a round trip time of the FSL.

15. The chirped waveform analysis system of claim 14, wherein the FSL is configured to be dispersive with a known relationship between the carrier wavelength and a round trip time of the FSL.

16. The chirped waveform analysis system of claim 14, further comprising:
a multiplexer configured to multiplex the n different wavelengths onto the optical beam.

17. The chirped waveform analysis system of claim 14, wherein the FSL further comprises an optical circulator configured to receive the optical beam from the acousto-optic frequency shifter, send the shifted optical beam to the plurality of optical filters, receive the optical beam from the plurality of optical filters, and output the optical beam.

18. The chirped waveform analysis system of claim 14, further comprising:
n electro-optical modulators configured to receive and be driven by an input radio frequency (RF) signal, the n electro-optical modulators configured to encode the input RF signal into laser light at a respective wavelength of the n wavelengths; and
a multiplexer configured to receive the encoded laser light from the n electro-optical modulators, combine the encoded laser light into the optical beam, and provide the optical beam to the FSL at a location in an optical path of the optical beam prior to the acousto-optic frequency shifter.

19. The chirped waveform analysis system of claim 18, further comprising:
a demultiplexer at an output of the FSL, the demultiplexer configured to receive the optical beam from the FSL and demultiplex the optical beam into the n wavelengths; and
n photodetectors configured to receive a respective wavelength of the n wavelengths and measure an intensity waveform of the respective wavelength and produce an analog electrical output responsive thereto, wherein
output from the demultiplexer is a unique order of the input RF signal.

20. The chirped waveform analysis system of claim 19, further comprising:
n analog-to-digital converters (ADCs) configured to receive the analog electrical output from the respective photodetectors, convert the received analog electrical output into a digital signal, and output the digital signal.

21. The chirped waveform analysis system of claim 20, further comprising:
a computing system or an oscilloscope configured to receive the digital signals output by the n ADCs and determine the FrFT order that was applied and the chirp rate that the FrFT order matches by a relationship between the frequency shift applied by the AOFS and the wavelength-dependent round trip time through the FSL, wherein
when the intensity waveform measured at a particular wavelength comprises a periodic train of individual sharp peaks separated by the loop transit time of the FSL, the chirp rate associated with the FrFT order applied for that wavelength is present in the input RF signal.

22. The chirped waveform analysis system of claim 14, further comprising:
an optical isolator configured to receive the output light from the multiplexer and the optical circulator; and
a first fiber optic coupler configured to receive output light from the optical isolator and provide portions of the received light to the demultiplexer and the FSL, wherein
the optical isolator is configured to let light propagate in a direction towards the fiber optic coupler, and
the first fiber optic coupler is configured to provide a larger portion of its received light to the FSL than to the demultiplexer.

23. The chirped waveform analysis system of claim 22, further comprising:
a second fiber optic coupler located between the multiplexer and the circulator and the optical isolator;
a first fiber optic arm connecting the multiplexer to the second fiber optic coupler; and
a second fiber optic arm connecting the optical circulator to the second fiber optic coupler, wherein
light traveling along the first arm takes one pass around the FSL, and
light traveling around the second arm takes multiple passes around the FSL.

24. The chirped waveform analysis system of claim 14, further comprising:
n lasers for each of the n electro-optical modulators, each of the n lasers configured to emit the laser light at the n respective wavelengths for each of the respective electro-optical modulators.

25. A chirped waveform analysis system, comprising:
a frequency-shifting loop (FSL) configured to receive an optical beam comprising n different wavelengths of laser light modulated in amplitude by an input radio frequency (RF) signal comprising one or more unknown signals, and configured to propagate the optical beam, the FSL comprising:
a frequency shifter configured to shift carrier frequencies of the optical beam by a fixed amount, wherein a magnitude of the frequency shift is selected based on parameters of the chirped waveform analysis system and a range of chirps to be measured for the one or more unknown signals in the input RF signal, and
n narrowband optical filters for each of the n wavelengths, the n narrowband optical filters configured to limit a number of round trips that the optical beam takes around the FSL;
an optical amplifier configured to receive and amplify the optical beam from the optical amplifier to compensate for optical losses in the FSL; and
an optical isolator configured to receive the amplified optical signal from the optical amplifier and ensure that the amplified optical signal travels in a direction of the optical circulator in the FSL; and
a first fiber optic coupler configured to receive output light from the optical isolator and provide portions of the received light to a demultiplexer and the FSL, wherein
the FSL is configured to be dispersive with a known relationship between the carrier wavelength and a round trip time of the FSL, and
the optical isolator is configured to let light propagate in a direction towards the fiber optic coupler.

26. The chirped waveform analysis system of claim 25, wherein the FSL further comprises an optical circulator configured to receive the optical beam from the acousto-optic frequency shifter, send the shifted optical beam to the plurality of optical filters, receive the optical beam from the plurality of optical filters, and output the optical beam.

27. The chirped waveform analysis system of claim 25, further comprising:
n electro-optical modulators configured to receive and be driven by an input radio frequency (RF) signal, the n electro-optical modulators configured to encode the input RF signal into laser light at a respective wavelength of the n wavelengths; and
the multiplexer, wherein
the multiplexer is configured to receive the encoded laser light from the n electro-optical modulators, combine the encoded laser light into the optical beam, and provide the optical beam to the FSL at a location in an optical path of the optical beam prior to the acousto-optic frequency shifter.

28. The chirped waveform analysis system of claim 25, further comprising:
a demultiplexer at an output of the FSL, the demultiplexer configured to receive the optical beam from the FSL and demultiplex the optical beam into the n wavelengths; and
n photodetectors configured to receive a respective wavelength of the n wavelengths and measure an intensity waveform of the respective wavelength and produce an analog electrical output responsive thereto; and
n analog-to-digital converters (ADCs) configured to receive the analog electrical output from the respective photodetectors, convert the received analog electrical output into a digital signal, and output the digital signal, wherein
output from the demultiplexer is a unique order of the input RF signal.

29. The chirped waveform analysis system of claim 28, further comprising:
a computing system or an oscilloscope configured to receive the digital signals output by the n ADCs and determine the FrFT order that was applied and the chirp rate that the FrFT order matches by a relationship between the frequency shift applied by the AOFS and the wavelength-dependent round trip time through the FSL, wherein
when the intensity waveform measured at a particular wavelength comprises a periodic train of individual sharp peaks separated by the loop transit time of the FSL, the chirp rate associated with the FrFT order applied for that wavelength is present in the input RF signal.
